(19) United States
(12) Patent Application Publication
(10) Pub. No.: US 2016/0378536 A1
(43) Pub. Date: Dec. 29, 2016

(54) CONTROL METHOD AND INFORMATION PROCESSING DEVICE

(71) Applicant: FUJITSU LIMITED, Kawasaki-shi (JP)

(72) Inventors: Ryota KURIBAYASHI, Numazu (JP); Kenji Hamano, Numazu (JP); Minoru Uchino, Fuji (JP); Fumiyasu Sugiyama, Mishima (JP); Makoto Hirokawa, Numazu (JP); Norie Arakawa, Numazu (JP)

(73) Assignee: FUJITSU LIMITED, Kawasaki-shi (JP)

(21) Appl. No.: 15/166,983

(22) Filed: May 27, 2016

(30) Foreign Application Priority Data
Jun. 24, 2015 (JP) 2015-126482

(51) Int. Cl. G06F 9/455

(52) U.S. Cl. CPC G06F 9/45558; G06F 2009/45575; G06F 2009/45595

(57) ABSTRACT

A control method executed by a computer includes determining which one of a first virtual machine that executes a real-time process and a second virtual machine that executes a batch process a virtual machine being operated is, stopping the virtual machine being operated, when a process executed by the virtual machine being operated is finished and the virtual machine being operated is the second virtual machine, and maintaining operation of the virtual machine being operated, when the process executed by the virtual machine being operated is finished and the virtual machine being operated is the first virtual machine.

### CROSS-REFERENCE TO RELATED APPLICATION

This application is based upon and claims the benefit of priority of the prior Japanese Patent Application No. 2015-126482, filed on Jun. 24, 2015, the entire contents of which are incorporated herein by reference.

### FIELD

The embodiment discussed herein is related to a deployment technique of virtual machines.

### BACKGROUND

Virtual machines (VMs) that operate in a cloud system are broadly divided into a VM (hereinafter, called a batch VM) that executes a batch process and a VM (hereinafter, called an online VM) that executes a real-time process.

The batch VM executes an automation test (for example, a middleware test), silent installation, a process of updating a VM template (for example, application of a patch), and a compile, for example. The batch VM collectively processes data, so that the batch VM fully uses allocated resources while processing the data.

The online VM is used for a manual test (for example, a middleware test impossible to automate), a coding, an environment construction (for example, installation of an operating system (OS) and a middleware), and a trouble investigation, for example. The online VM executes a process in response to a request, so that the online VM (in particular, a central processing unit (CPU) and an input/output (I/O)) consumes a small amount of resources when there is no request. Here, there is a related art that allocates resources by focusing on the types of VMs. The related technique is disclosed in Japanese Laid-open Patent Publication No. 2013-196062.

### SUMMARY

According to an aspect of the invention, a control method executed by a computer includes determining which one of a first virtual machine that executes a real-time process and a second virtual machine that executes a batch process a virtual machine being operated is, stopping the virtual machine being operated, when a process executed by the virtual machine being operated is finished and the virtual machine being operated is the second virtual machine, and maintaining operation of the virtual machine being operated, when the process executed by the virtual machine being operated is finished and the virtual machine being operated is the first virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overview of a system according to the present embodiment;

FIG. 2 is a hardware configuration diagram of a physical machine;

FIG. 3 is a function block diagram of the physical machine;

FIG. 4 is a diagram illustrating an example of a control block;

FIG. 5 is a diagram illustrating an example of data stored in a type data storing unit;

FIG. 6 is a flowchart illustrating a process flow of a process executed by a type change processing unit;

FIG. 7 is a flowchart illustrating a process flow of another process executed by the type change processing unit;

FIG. 8 is a flowchart illustrating a process flow of still another process executed by the type change processing unit;

FIG. 9 is a flowchart illustrating a process flow of a process executed by a process monitoring unit;

FIG. 10 is a flowchart illustrating a process flow of a process executed by a second changing unit;

FIG. 11 is a flowchart illustrating a process flow of a process executed by a first changing unit;

FIG. 12 is a flowchart illustrating a process flow of a process executed by a resource monitoring unit;

FIG. 13 is a flowchart illustrating a process flow of another process executed by the resource monitoring unit;

FIG. 14 is a flowchart illustrating a process flow of still another process executed by the resource monitoring unit;

FIG. 15 is a graph for explaining calculation of a threshold value; and

FIG. 16 is a graph for explaining a relation between execution of VMs and a resource use rate.

### DESCRIPTION OF EMBODIMENT

A large number of users utilize a cloud system, differently from an on-premises system. This makes it difficult to perform such an operation that only a batch VM or an online VM is operated in a specific time slot, and creates a time slot when both of the batch VM and the online VM are executed. Requests for a real-time process are more frequently generated specially during a daytime time slot than during a night time slot, so that the execution of both of the batch VM and the online VM might result in a shortage of resources to be allocated to the online VM due to a conflict of the resources.

The related art is based on the premise that sufficient resources to be allocated for a VM are present, so that a performance of a real-time process might not be secured in a case where the resources are insufficient.

An aspect of the technology disclosed in the embodiment suppresses the performance degradation of the real-time process due to a shortage of resources.

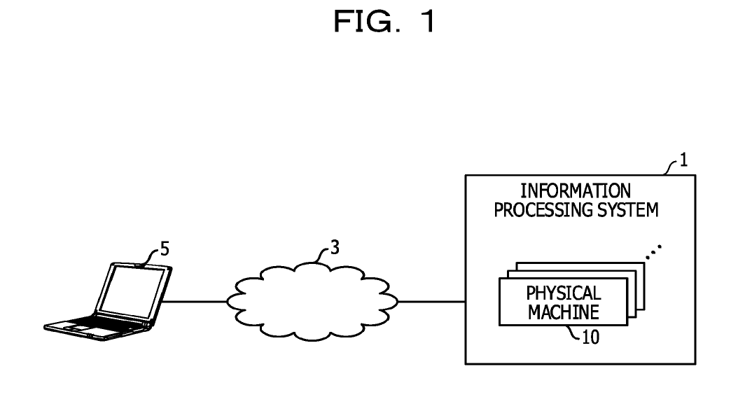

FIG. 1 illustrates an overview of a system according to the present embodiment. An information processing system 1 and a user terminal 5 are connected to a network 3 that is the Internet, for example. The information processing system 1 includes multiple physical machines 10. Each physical machine 10 executes deployment of virtual machines in response to a request received from the user terminal 5.

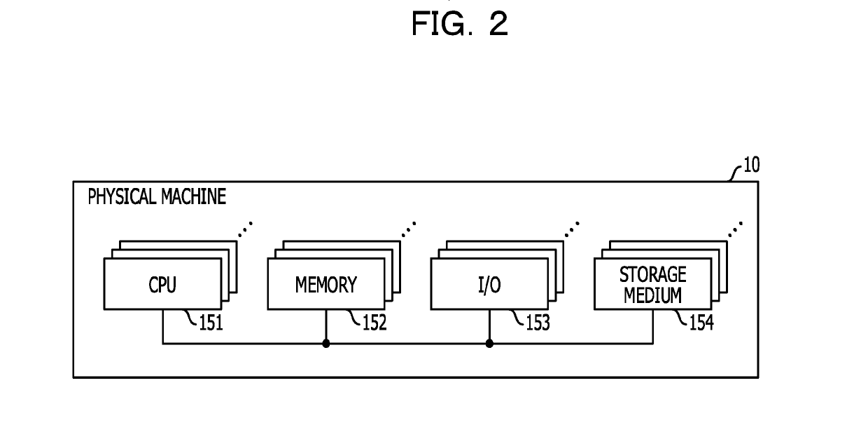

FIG. 2 illustrates a hardware configuration diagram of the physical machine 10. The physical machine 10 includes one or multiple CPUs 151, one or multiple memories 152, one or multiple I/Os 153, and one or multiple storage media 154. The I/O 153 is a physical port, for example. The storage medium 154 is a nonvolatile storage medium. The CPUs 151, the memories 152, and the I/Os 153 are connected via a bus.

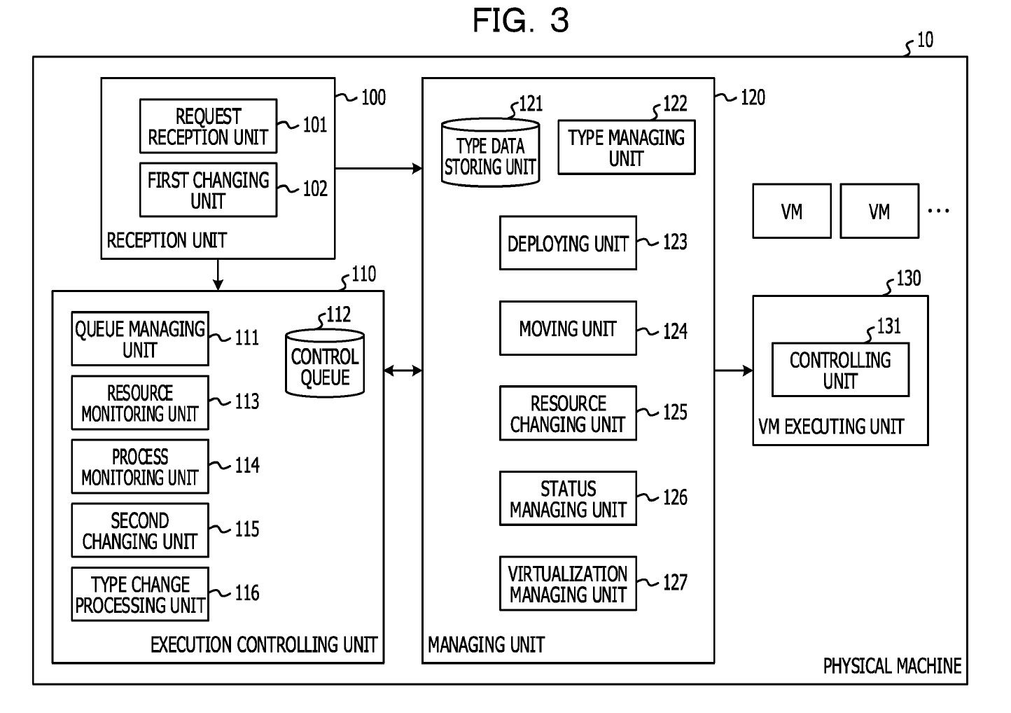

A program for executing a process in the present embodiment is loaded on the memory 152 and executed by the CPU 151 to implement various kinds of functions illustrated in FIG. 3. FIG. 3 illustrates a function block diagram of the physical machine 10. The physical machine 10 includes a reception unit 100, an execution controlling unit 110, a managing unit 120, a VM executing unit 130, and multiple VMs executed by the VM executing unit 130. Note that, an example in which the abovementioned functions are implemented in one physical machine 10 is indicated herein, but the abovementioned functions may be implemented in the multiple physical machines 10. Moreover, the reception unit 100, the execution controlling unit 110, and the managing unit 120 may be implemented by one or multiple virtual machines.

The reception unit 100 includes a request reception unit 101 and a first changing unit 102.

When the request reception unit 101 receives a deployment request from the user terminal 5 to deploy a VM, the request reception unit 101 instructs a deploying unit 123 in the managing unit 120 to deploy the VM by an on-demand instruction. Moreover, when the request reception unit 101 receives a return request from the user terminal 5 to return a VM, the request reception unit 101 instructs the deploying unit 123 in the managing unit 120 to return the VM by an on-demand instruction. The on-demand instruction includes information on an OS type, a VM name, information indicating an execution state of the VM, information on resources (for example, information on a CPU, a memory, a disk size, and a traffic amount), an Internet Protocol (IP) address, and information on a VM type. When a VM is deployed, the VM type is set to an “online VM”. As described above, the online VM is a VM that executes a real-time process, and the batch VM is a VM that executes a batch process. The VM name is assigned by a user. The execution state of the VM is set to any one of “during execution”, “temporary stop”, and “stop”. In a case of the “during execution”, the batch VM is turned on, and in cases of the “temporary stop” and the “stop”, the batch VM is not turned on. Further, in the case of the “temporary stop”, data to be used for a batch process is stored in the storage medium 154, and the batch process is resumed using the data at the time of a restart. Note that, in the present embodiment, the execution state of a batch VM is managed with a control block, the execution state of an online VM is not managed.

When the first changing unit 102 receives a change request from the user terminal 5 to change the VM type, the first changing unit 102 causes a type change processing unit 116 to change the VM type in accordance with the content of the change request. The VM type is changed from the online VM to the batch VM or changed from the batch VM to the online VM.

Further, the time when a request for a real-time process is received from the user terminal 5 is unknown, so that the online VM is preferably being operated continuously specially during the daytime time slot so as to maintain the performance of the real-time process. In the present embodiment, an operation of the online VM is maintained until an explicit stop instruction is given or the operation is stopped in accordance with a schedule. On the other hand, after the batch process is finished, it is possible to stop the batch VM. In the present embodiment, the batch VM in which the batch process is finished is stopped in principle. Further, the batch VM consumes the comparatively low amount of resources after the batch process is finished.

The execution controlling unit 110 includes a queue managing unit 111, a control queue 112, a resource monitoring unit 113, a process monitoring unit 114, a second changing unit 115, and the type change processing unit 116.

The queue managing unit 111 manages a control block stored in the control queue 112. Moreover, the queue managing unit 111 instructs a type managing unit 122 in the managing unit 120 to update data stored in a type data storing unit 121.

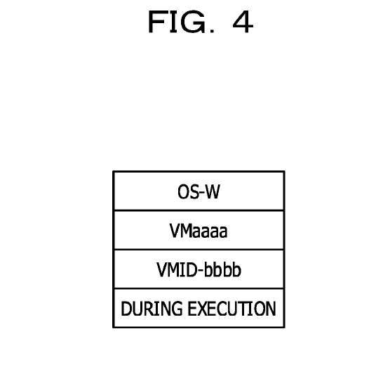

The control queue 112 stores therein a control block. FIG. 4 illustrates an example of a control block. The control block is data for managing a batch VM, and includes information on an OS type, a VM name of the batch VM, a VM identifier of the batch VM, and information indicating an execution state of the batch VM. The VM identifier is a unique character string that is allocated to each VM.

The resource monitoring unit 113 acquires information on resources in the physical machine 10 from the managing unit 120, and monitors a use status of the resources. A threshold value εₙ that is used by the resource monitoring unit 113 for monitoring may be set to a fixed value by a user, or may be dynamically changed by the resource monitoring unit 113. A threshold value εₙ is set to each of the CPU 151 and the memory 152.

The process monitoring unit 114 acquires, for example, on a periodic basis, information on an execution state of VMs in the physical machine 10 from the managing unit 120, and monitors the execution state of the VMs. Moreover, the process monitoring unit 114 causes the type change processing unit 116 to change the VM type in accordance with the execution state of the VMs.

The second changing unit 115 determines, for example, on a periodic basis, whether the VM satisfies a determination condition, and causes the type change processing unit 116 to change the VM type in accordance with a determination result.

The type change processing unit 116 executes a first type change process and a second type change process, which are described later, in response to calls from the process monitoring unit 114, the first changing unit 102, and the second changing unit 115.

The managing unit 120 includes the type data storing unit 121, the type managing unit 122, the deploying unit 123, a moving unit 124, a resource changing unit 125, a status managing unit 126, a virtualization managing unit 127.

The type managing unit 122 manages data stored in the type data storing unit 121.

When the deploying unit 123 is instructed to deploy a VM by an on-demand instruction, the deploying unit 123 transmits an execution instruction to deploy the VM to the VM executing unit 130. Moreover, when the deploying unit 123 is instructed to return a VM by an on-demand instruction, the deploying unit 123 transmits an execution instruction to return the VM to the VM executing unit 130. Further, the deploying unit 123 allocates a VM identifier to the VM when the deployment is completed, and notifies a user of the VM of the VM identifier. The notification is performed by an e-mail or a display on a display device, for example.

The moving unit 124 transmits an execution instruction for migration of a VM to the VM executing unit 130. The migration of the VM is executed, for example, when the processing load of a physical machine 10 exceeds a threshold value.

The resource changing unit 125 transmits an execution instruction for a change of the amount of resources (for example, the number of CPUs, the use rate of CPUs, the memory amount, the disk capacity, the number of networks, and the like) that are allocated to a VM executed in the physical machine 10, to the VM executing unit 130.

The status managing unit 126 acquires information on the amount of resources of the VM in the physical machine 10, for example, on a periodic basis, from the VM executing unit 130, and transmits the information to the execution controlling unit 110.

the virtualization managing unit 127 executes a process of monitoring an execution state and the like of the VM, and transmits information on the execution state and the like of the VM to the execution controlling unit 110.

The VM executing unit 130 includes a controlling unit 131 that is a hypervisor, for example. The controlling unit 131 executes an executable VM that is turned on. When the controlling unit 131 receives an execution instruction from the managing unit 120, the controlling unit 131 executes the deployment, the return, the migration, or the like of the VM in accordance with the execution instruction. The controlling unit 131 transmits information on resources used by the VM to the managing unit 120.

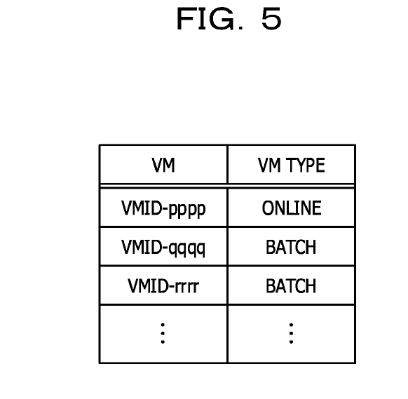

FIG. 5 illustrates an example of data stored in the type data storing unit 121. In the example of FIG. 5, a VM identifier and information on the VM type are stored.

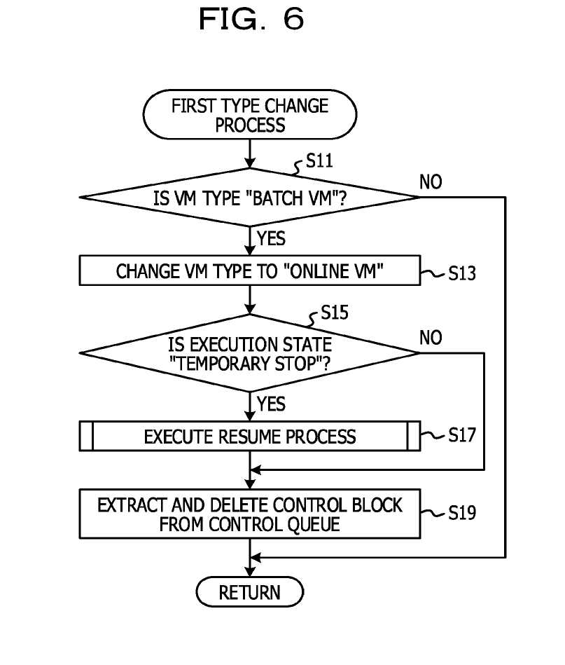

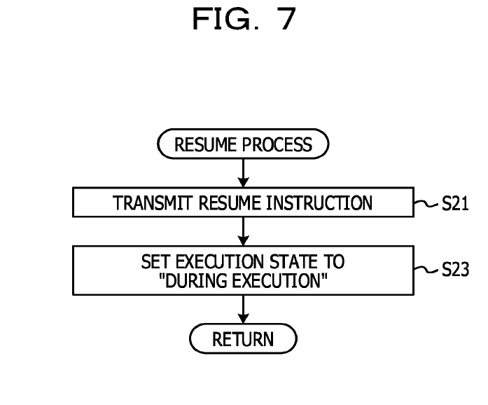

Next, a process executed in the physical machine 10 will be described using FIGS. 6 to 16. Firstly, a first type change process executed by the type change processing unit 116 will be described using FIGS. 6 and 7. This process is executed by being called by the process monitoring unit 114, the second changing unit 115, or the first changing unit 102.

A VM that is a target of this process is called a target VM. Firstly, the type change processing unit 116 determines whether the VM type of a target VM is the “batch VM” (FIG. 6: Step S11). If the VM type of the target VM is not the “batch VM” (Step S11: No route), the process returns to a process in a calling source. On the other hand, if the VM type of the target VM is the “batch VM” (Step S11: Yes route), the type change processing unit 116 changes the VM type of the target VM in a control block from the “batch VM” to the “online VM” via the queue managing unit 111 (Step S13). Moreover, the type change processing unit 116 instructs the type managing unit 122 in the managing unit 120 to change the VM type of the target VM. In response to this instruction, the type managing unit 122 changes information on the VM type of the target VM that is stored in the type data storing unit 121 from the “batch VM” to the “online VM”.

The type change processing unit 116 determines whether an execution state of the target VM in the control block is the “temporary stop” (Step S15). If the execution state of the target VM in the control block is not the “temporary stop” (Step S15: No route), the process is shifted to a process at Step S19. On the other hand, the execution state of the target VM in the control block is the “temporary stop” (Step S15: Yes route), the type change processing unit 116 executes a resume process for the target VM (Step S17). The resume process will be described using FIG. 7. Note that, although the resume process includes a process of resuming the target VM as a batch VM and a process of resuming the target VM as an online VM, it is assumed that the target VM is resumed as an online VM in the resume process at Step S17.

Firstly, the type change processing unit 116 transmits a resume instruction that instructs the VM executing unit 130 to resume the target VM via the managing unit 120 (FIG. 7: Step S21). In response to the resume instruction, the controlling unit 131 in the VM executing unit 130 turns on the target VM, and resumes the target VM as an online VM. Further, if the target VM is resumed as an online VM, the controlling unit 131 turns on the target VM, and causes the target VM to resume a process with data (for example, a context) stored in the storage medium 154 before the temporary stop. Further, the resume process of a VM is a well-known process, and thus, a detailed explanation thereof is omitted herein.

The type change processing unit 116 changes the execution state of the target VM in the control block from the “temporary stop” to the “during execution” (Step S23). Then, the process is returned to the process in the calling source.

Returning to the explanation of FIG. 6, the type change processing unit 116 extracts a control block of the target VM from the control queue 112, and deletes the control block (Step S19). Then, the process is returned to the process in the calling source.

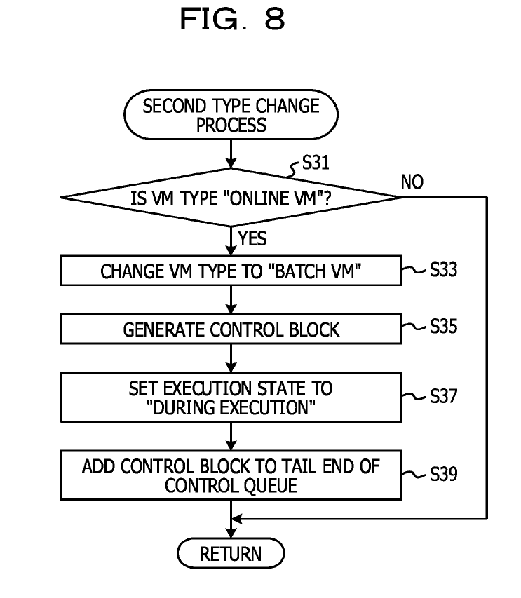

Next, a second type change process executed by the type change processing unit 116 will be described using FIG. 8. This process is executed by being called by the second changing unit 115 or the first changing unit 102.

Firstly, the type change processing unit 116 determines whether the VM type of a target VM is the “online VM” (FIG. 8: Step S31). If the VM type of the target VM is not the “online VM” (Step S31: No route), the process returns to a process in a calling source. On the other hand, if the VM type of the target VM is the “online VM” (Step S31: Yes route), the type change processing unit 116 changes the VM type of the target VM in a control block from the “online VM” to the “batch VM” via the queue managing unit 111 (Step S33). Moreover, the type change processing unit 116 instructs the type managing unit 122 in the managing unit 120 to change the VM type of the target VM. In response to this instruction, the type managing unit 122 changes information on the VM type of the target VM that is stored in the type data storing unit 121 from the “online VM” to the “batch VM”.

The type change processing unit 116 generates a control block for the target VM (Step S35). Further, the type change processing unit 116 sets an execution state in the generated control block to the “during execution” (Step S37). The OS type, the VM name, the VM identifier, and the like are set at Step S37.

The type change processing unit 116 adds the control block for the target VM to the tail end of the control queue 112 (Step S39). Then, the process is returned to the process in the calling source.

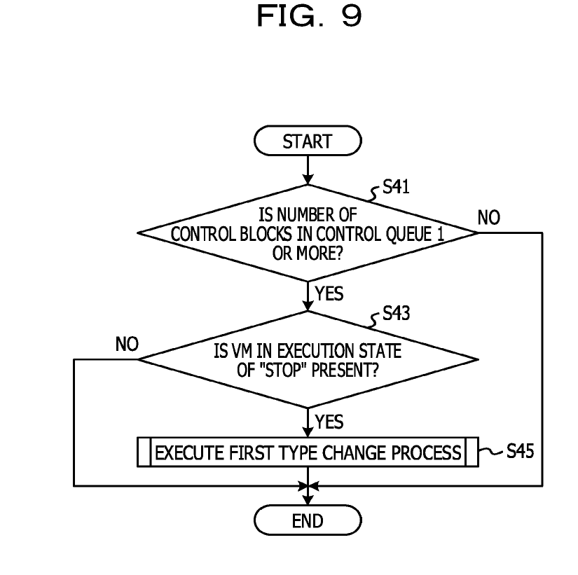

Next, a process executed by the process monitoring unit 114 will be described using FIG. 9. This process is executed, for example, on a periodic basis.

Firstly, the process monitoring unit 114 determines whether the number of control blocks stored in the control queue 112 is 1 or more (FIG. 9: Step S41).

If the number of control blocks stored in the control queue 112 is less than 1 (Step S41: No route), the process is finished. On the other hand, if the number of control blocks stored in the control queue 112 is 1 or more (Step S41: Yes route), the process monitoring unit 114 determines whether a control block for a VM (herein, a batch VM) the execution state of which is “stop” is present in the control queue 112 (Step S43).

If no control block for a VM the execution state of which is “stop” is present in the control queue 112 (Step S43: No route), the process is finished. On the other hand, a control block for a VM the execution state of which is “stop” is present in the control queue 112 (Step S43: Yes route), the process monitoring unit 114 calls the type change processing unit 116. In response to the call, the type change processing unit 116 executes the first type change process on the VM the execution state of which is “stop” (Step S45). The first type change process is already explained using FIGS. 6 and 7. The process is then finished.

The execution of the processes as the above allows a system to detect the completion of the batch process, change the VM from a batch VM to an online VM, and exclude the VM from the targets of an automatic execution control. Further, an online VM being stopped is started up in accordance with a schedule set in advance or in accordance with a start-up instruction.

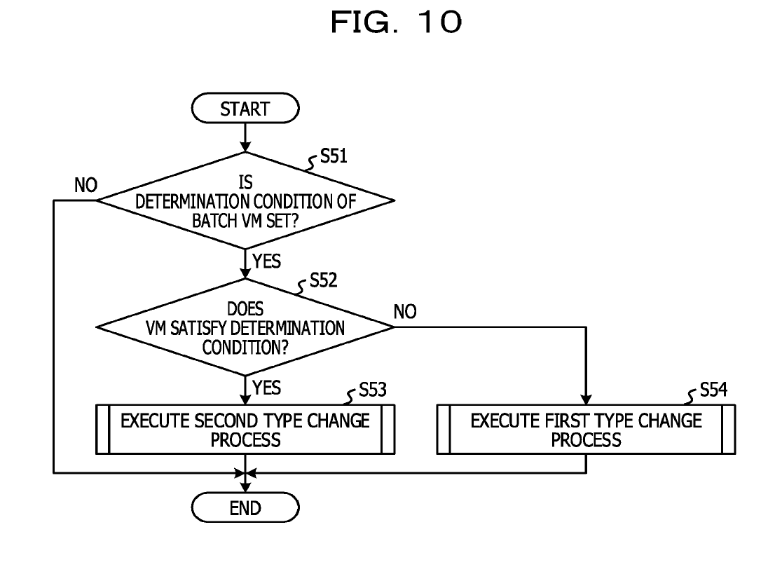

Next, a process executed by the second changing unit 115 will be described using FIG. 10. This process is executed, for example, on a periodic basis. Note that, this process is executed to all the VMs, however, a case where the process is executed to one VM (hereinafter, called a target VM) will be described herein as an example, for easy explanation.

Firstly, the second changing unit 115 determines whether a user or an administrator sets a determination condition of a batch VM (FIG. 10: Step S51). The determination condition of a batch VM is a condition for determining whether a VM being operated is a batch VM. In the present embodiment, a VM that satisfies at least any one of determination conditions as follows is determined as a batch VM.

(1) A VM the traffic amount of which is a predetermined value (for example, 0) or less. The VM the traffic amount of which is a predetermined value or less highly probably executes a silent installation, a compiling process, or the like, that is a batch process. Information on the traffic amount may be acquired from the status managing unit 126.

(2) A VM that operates without receiving any input from a user. It is considered that the VM that operates without receiving any input from a user does not execute a real-time process for a manual test, coding, an environment construction, a trouble investigation, and the like (in other words, the VM is a batch VM). The input is an input made by a mouse or a key board, for example. The input from the user is detected by introducing agent software for receiving change in the mouse coordinates and the key input, for example, into the VM.

(3) A VM in which a response of a user with respect to a question is not detected. For example, when a character string for asking a question to the user is transmitted to the user terminal 5 by agent software that is introduced in to the VM, and a response with respect to the question is not detected, it is determined that the VM is a batch VM.

(4) A VM in which a communication at a specific network port (for example, a secure shell (SSH) port of the port number of 22 or a remote desktop protocol (RDP) port of the port number of 3389) is not established. Introducing agent software that monitors a session of an OS, for example, into the VM makes it possible to determine whether a communication at a specific network port is established.

If a determination condition of a batch VM is not set by a user or an administrator (Step S51: No route), the process is finished. On the other hand, a determination condition of a batch VM is set by a user or an administrator (Step S51: Yes route), the second changing unit 115 determines whether the target VM satisfies the determination condition (Step S52).

If the target VM does not satisfy the determination condition (Step S52: No route), the second changing unit 115 instructs the type change processing unit 116 to execute the first type change process. In response to this instruction, the type change processing unit 116 executes the first type change process (Step S54). The first type change process is already explained using FIGS. 6 and 7, and thus an explanation thereof is omitted.

On the other hand, if the target VM satisfies the determination condition (Step S52: Yes route), the second changing unit 115 instructs the type change processing unit 116 to execute the second type change process. In response to this instruction, the type change processing unit 116 executes the second type change process on the target VM (Step S53). The second type change process is already explained using FIG. 8, and thus an explanation thereof is omitted. The process is then finished.

The processes as the above makes it possible to automatically change the type of a VM that satisfies a determination condition to a “batch VM”, and temporarily stop the batch VM when it is determined that resources are short with respect to a threshold value to allow an online VM to utilize the resources. This reduces the degradation or the like of the response property of the online VM, and allows the effective utilization of the resources.

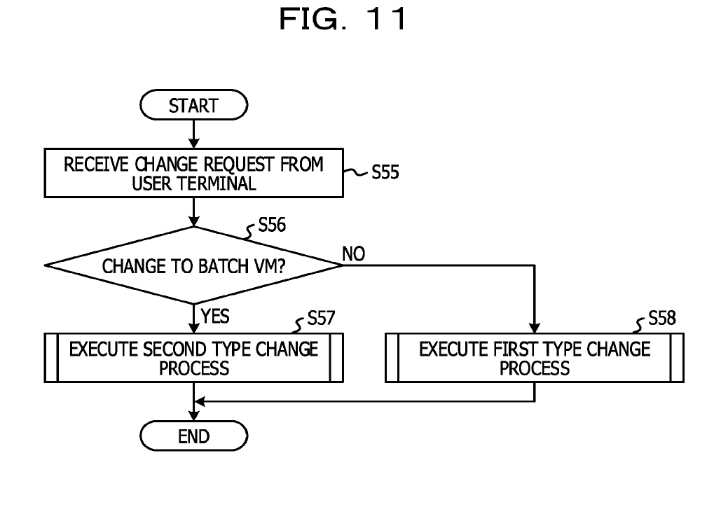

Next, a process executed by the first changing unit 102 will be described using FIG. 11.

Firstly, the first changing unit 102 receives a change request from the user terminal 5 to change the VM type (FIG. 11: Step S55). The change request includes a VM name or a VM identifier, and designation of a VM type.

The first changing unit 102 determines whether a change to a batch VM is designated in the change request (Step S56). If a change to a batch VM is designated in the change request (Step S56: Yes route), the first changing unit 102 instructs the type change processing unit 116 to execute the second type change process. In response to this instruction, the type change processing unit 116 executes the second type change process on a VM that is specified by the VM name or the VM identifier (Step S57). The process is then finished. The second type change process is already explained using FIG. 8, and thus an explanation thereof is omitted.

On the other hand, if a change to a batch VM is not designated in the change request (Step S56: No route), the first changing unit 102 instructs the type change processing unit 116 to execute the first type change process. In response to this instruction, the type change processing unit 116 executes the first type change process (Step S58). The process is then finished. The first type change process is already explained using FIGS. 6 and 7, and thus an explanation thereof is omitted.

The execution of the processes as the above allows the VM type to be changed in accordance with the intention of the user.

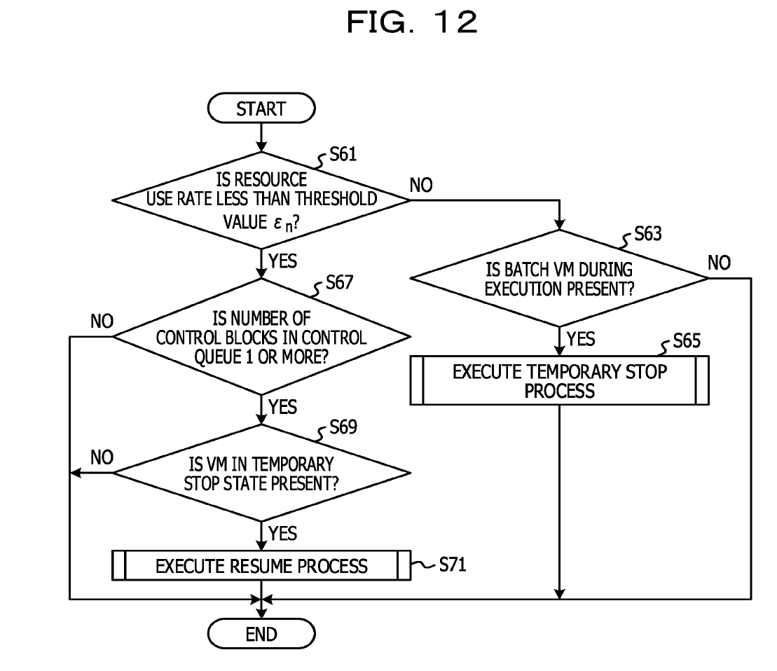

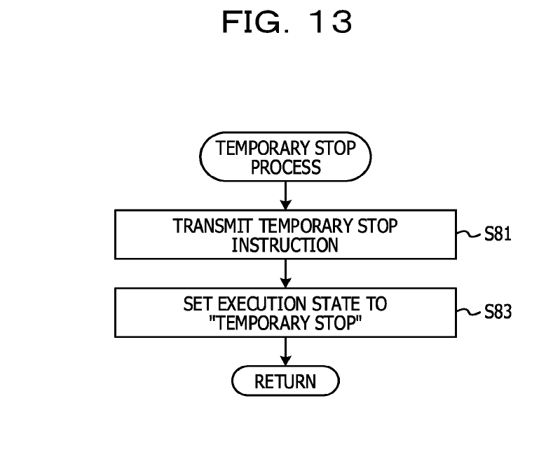

Next, a process executed by the resource monitoring unit 113 will be described using FIGS. 12 and 13. This process is executed to the CPU 151 and the memory 152 on a periodic basis.

Firstly, the resource monitoring unit 113 determines whether the resource use rate is less than a threshold value εₙ (FIG. 12: Step S61). If the resource use rate is not less than the threshold value εₙ (Step S61: No route), the resource monitoring unit 113 determines whether a control block of a batch VM the execution state of which is the “during execution” is present in the control queue 112 (Step S63).

If no control block of a batch VM the execution state of which is the “during execution” is present in the control queue 112 (Step S63: No route), the process is finished. On the other hand, a control block of a batch VM the execution state of which is the “during execution” (hereinafter, called a target VM) is present in the control queue 112 (Step S63: Yes route), the resource monitoring unit 113 executes a temporary stop process (Step S65). The temporary stop process will be described using FIG. 13.

Firstly, the resource monitoring unit 113 transmits a temporary stop instruction that instructs the VM executing unit 130 to temporarily stop the target VM via the managing unit 120 (FIG. 13: Step S81). In response to the temporary stop instruction, the controlling unit 131 in the VM executing unit 130 temporarily stops the target VM. Specifically, the controlling unit 131 stores data used by the target VM in the storage medium 154, and turns off the target VM. Further, the temporary stop process of a VM is a well-known process, and thus, a detailed explanation thereof is omitted herein.

The process monitoring unit 114 changes the execution state of the target VM in the control block from the “during execution” to the “temporary stop” (Step S83). Then, the process is returned to a process in a calling source (FIG. 12), and the process is finished.

On the other hand, if the resource use rate is less than the threshold value εₙ (Step S61: Yes route), the resource monitoring unit 113 determines whether the number of control blocks in the control queue 112 is 1 or more (Step S67). If the number of control blocks is less than 1 (Step S67: No route), the process is finished. On the other hand, if the number of control blocks is 1 or more (Step S67: Yes route), the resource monitoring unit 113 determines whether a control block of a batch VM the execution state of which is the “temporary stop” is stored in the control queue 112 (Step S69).

If no control block of a batch VM the execution state of which is the “temporary stop” is stored in the control queue 112 (Step S69: No route), the process is finished. On the other hand, if a control block of a batch VM the execution state of which is the “temporary stop” (herein, called a target VM) is stored in the control queue 112 (Step S69: Yes route), the resource monitoring unit 113 instructs the process monitoring unit 114 to execute the resume process. In response to this instruction, the process monitoring unit 114 executes the resume process for the target VM (Step S71). The process is then finished. The resume process is already explained using FIG. 7, however, a process of resuming the target VM as a batch VM is performed herein, differently from the case at Step S17.

The execution of the processes as the above makes it possible to temporarily stop and resume a batch VM as appropriate in accordance with the resource use rate, reducing the degradation of the processing performance of the online VM due to the shortage of resources and allowing the effective utilization of the resources.

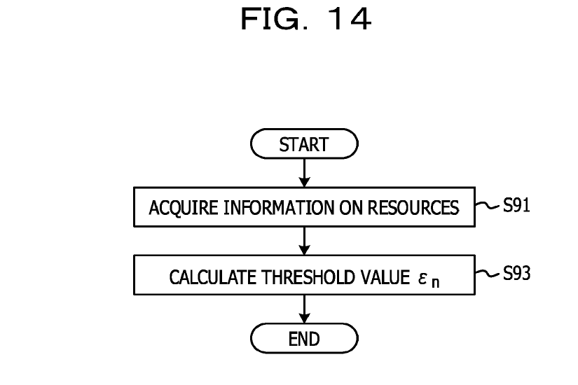

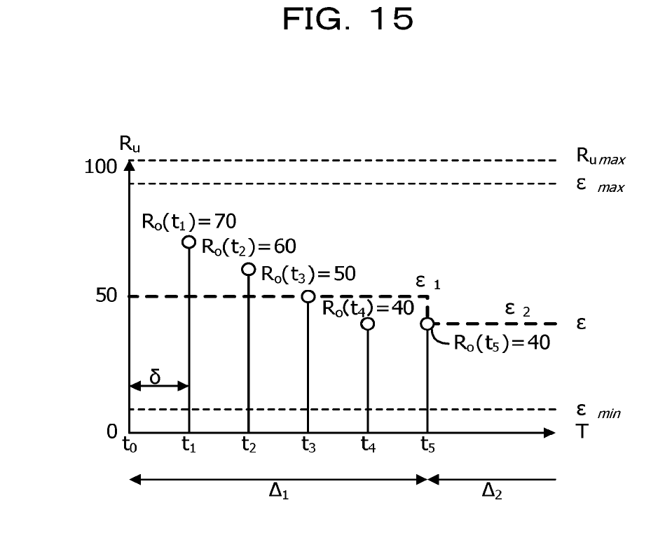

Next, a process of calculating a threshold value εₙ will be described using FIGS. 14 and 15. This process is executed, for example, on a periodic basis.

Firstly, the resource monitoring unit 113 acquires information on resources in the physical machine 10 from the managing unit 120 (FIG. 14: Step S91).

The resource monitoring unit 113 calculates a threshold value εₙ based on the information acquired at Step S91 (Step S93). The process is then finished. The threshold value εₙ calculated at Step S93 is used in the processes explained using FIGS. 12 and 13.

Calculation of the threshold value εₙ will be described using FIG. 15. In FIG. 15, a horizontal axis t represents the time, and a longitudinal axis R represents the resource use rate (%). A symbol Rᵤₘₐₓ indicates a maximum value of the use rate, and a symbol Ro indicates a resource use rate of all the online VMs. A symbol k indicates the number of samplings, a symbol δ indicates a sampling interval, and a symbol Δ(=k*δ) indicates a unit monitoring period. A symbol εₘₐₓ indicates an upper limit of a threshold value, and a symbol εₘᵢₙ indicates a lower limit of the threshold value. The resource use rate of each online VM that is used for calculation of Ro is sampled k times during the unit monitoring period. In FIG. 15, the number of samplings k is 5, and the sampling interval δ is 1.

An initial value ε₁ of the threshold value εₙ is set to 50 that is ½ of Rᵤₘₐₓ. The sampling is executed from a sampling time t₁ to a sampling time t₅ during the Δ₁ to calculate Ro. When Ro is calculated, ε₂ that is a threshold value for Δ₂ is calculated. Further, a threshold value εₙ during a monitor interval Δₙ is given by a formula below.

$${ɛ}_{n} = ( {ɛ}_{n - 1} ) - {\sum }_{c = 1}^{k} \{ {R}_{o} ( {t}_{c} ) - ( {ɛ}_{n - 1} ) \}$$

$$s . t . {ɛ}_{max} \geq {ɛ}_{n} \geq {ɛ}_{min}$$

Therefore, ε₂ is calculated as follows.

ε₂=(ε₂₋₁)−[{Rₒ(t₁)−(ε₂₋₁)}+{Rₒ(t₂)−(ε₂₋₁)}+ . . . +{Rₒ(t₅)−(ε₂₋₁)}]

ε₂=(50)−[{70−50}+{60−50}+{50−50}+{40−50}+{40−50}]

ε₂=(50)−[+10]

∴ε₂=40

The threshold value ε₂ is 40, which is smaller than ε₁, making it more difficult for a batch VM to be executed.

Accordingly, the resource use rate Ro that is calculated during a monitor interval Δₙ exceeding the threshold value εₙ results in a smaller threshold value εₙ₊₁ that is used during the next monitor interval Δₙ₊₁. In contrast, the resource use rate Ro that is calculated during the given monitor interval Δₙ not exceeding the threshold value εₙ results in a larger threshold value εₙ₊₁ that is used during the next monitor interval Δₙ₊₁.

This allows a suitable threshold value to be calculated even in a case where the resource use rate of the online VM largely fluctuates every day and is difficult to be predicted.

Further, the introduction of εₘₐₓ and εₘᵢₙ makes it possible to keep the threshold value εₙ from becoming an unsuitable value when an significantly large or small Ro is calculated.

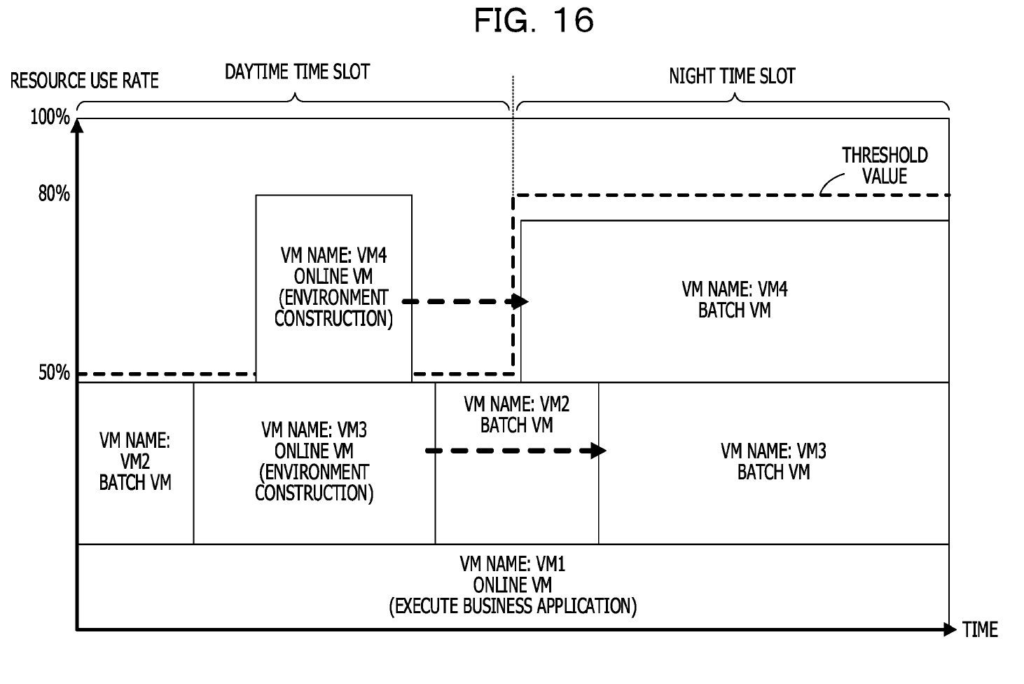

A relation between the execution of VMs and the resource use rate will be described using FIG. 16. In FIG. 16, the horizontal axis represents the time, and the longitudinal axis represents the resource use rate. The dashed line represents a threshold value. A VM1 that is an online VM and a VM2 that is a batch VM are executed at a first stage, and with a start-up of a VM3 that is an online VM, the resource use rate exceeding a threshold value is detected. Therefore, the VM2 that is the batch VM is temporarily stopped. A VM4 is started up after the VM3 is started up, and the resource use rate exceeds the threshold value. However, the VMs are not temporarily stopped because only the online VMs are being executed. After the VM3 and the VM4 are stopped, the resource use rate becomes less than the threshold value, and thus the batch process of the VM2 is resumed. Then, after the batch process of the VM2 is finished, the VM2 is stopped. Meanwhile, the VM3 and the VM4 are changed from the online VMs to the batch VMs during the night time slot and execute the batch processes. In the example of FIG. 16, a threshold value during the daytime time slot is 50(%), and a threshold value during the night time slot is 80(%).

One embodiment of the present disclosure has been explained in the foregoing; however, the present disclosure is not limited to this embodiment. For example, the function block configuration of the physical machine 10 explained in the foregoing may not correspond with an actual program module configuration in some cases.

Moreover, the configuration of each table explained in the foregoing is merely an example, and is not limited thereto. In addition, in the process flow, the order of the processes may be interchanged as long as the process result is not changed. In addition, the processes may be executed in parallel.

The embodiment of the present disclosure described in the foregoing is summarized as follows.

A control method according to the present embodiment includes processes of: (A) determining which one of a virtual machine that executes a real-time process and a virtual machine that executes a batch process a virtual machine being operated is; and (B) when the process executed by the virtual machine is finished, based on a determination result, stopping the virtual machine in a case where the virtual machine is a virtual machine that executes a batch process, or maintaining the operation of the virtual machine in a case where the virtual machine is a virtual machine that executes a real-time process.

This makes it possible to curb the occupation of the resources by the virtual machine that executes the batch process, thereby making it possible to suppress the performance degradation of the real-time process due to the shortage of resources.

Moreover, the present control method may include processes of: (C) determining whether a resource use rate in a computer exceeds a threshold value; and (D) temporarily stopping the virtual machine, when the resource use rate in the computer exceeds the threshold value and the virtual machine is a virtual machine that executes a batch process. This reduces the consumption of the resources due to the batch process. Moreover, since the virtual machine is temporarily stopped, this also allows the virtual machine to resume the batch process later.

Moreover, the present control method may further include a process of (E) resuming an operation of another virtual machine being temporarily stopped when the use rate in the computer does not exceed the threshold value. This effectively utilize resources while suppressing the degradation of the performance of the real-time process.

Moreover, the present control method may further include processes of: (F) determining whether a state of a virtual machine is in a predetermined state; and (G) changing, when the state of the virtual machine is in a predetermined state and the virtual machine is a virtual machine that executes a real-time process, the virtual machine to a virtual machine that executes a batch process. This makes it possible to automatically change the type of the virtual machine.

Moreover, the present control method may further include a process of (G) changing, when the state of the virtual machine is not in the predetermined state and the virtual machine is a virtual machine that executes a batch process, the virtual machine to a virtual machine that executes a real-time process. This makes it possible to automatically change the type of the virtual machine.

Moreover, the present control method may further include a process of (H) calculating the threshold value based on the resource use rate in the computer during a most recent predetermined period.

Moreover, the predetermined state described above may include at least any one of a state where a traffic amount of the virtual machine is a predetermined value or less, a state where the virtual machine operates without receiving any input from a user, and a state where the virtual machine does not establish a communication at a network port of a predetermined port number.

Further, a program to allow a processor to execute the processes by the abovementioned method may be created, and the program is stored in, for example, a computer readable storage medium such as a flexible disk, a CD-ROM, a magneto-optical disk, a semiconductor memory, or a hard disk, or a storage memory. Note that, a midway process result is temporarily kept in a storage memory such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control method executed by a computer, the control method comprising:
determining which one of a first virtual machine that executes a real-time process and a second virtual machine that executes a batch process a virtual machine being operated is;
stopping the virtual machine being operated, when a process executed by the virtual machine being operated is finished and the virtual machine being operated is the second virtual machine; and
maintaining operation of the virtual machine being operated, when the process executed by the virtual machine being operated is finished and the virtual machine being operated is the first virtual machine.

2. The control method according to claim 1, further comprising:
determining whether a use rate of resources of the computer exceeds a threshold value; and
temporarily stopping the virtual machine being operated, when the use rate exceeds the threshold value and the virtual machine being operated is the second virtual machine.

3. The control method according to claim 2, further comprising:
resuming another virtual machine being temporarily stopped when the use rate does not exceed the threshold value.

4. The control method according to claim 3, further comprising:
determining whether the virtual machine being operated is in a specific state; and
when the virtual machine being operated is in the specific state and the virtual machine being operated is the first virtual machine, changing the virtual machine being operated to the second virtual machine.

5. The control method according to claim 4, further comprising:
when the virtual machine being operated is not in the specific state and the virtual machine being operated is the second virtual machine, changing the virtual machine being operated to the first virtual machine.

6. The control method according to claim 5, wherein the specific state includes at least any one of a state where a traffic amount is a specific value or less, a state where the virtual machine is operating without receiving any input from a user, and a state where the virtual machine does not establish a communication at a network port of a specific port number.

7. The control method according to claim 2, further comprising:
determining the threshold value based on the use rate during a most recent specific period.

8. An information processing device comprising:
a memory; and
a processor coupled to the memory and configured to:
determine which one of a first virtual machine that executes a real-time process and a second virtual machine that executes a batch process a virtual machine being operated is,
stop the virtual machine being operated, when a process executed by the virtual machine being operated is finished and the virtual machine being operated is the second virtual machine, and
maintain operation of the virtual machine being operated, when the process executed by the virtual machine being operated is finished and the virtual machine being operated is the first virtual machine.

9. The information processing device according to claim 8, wherein the processor is configured to:
determine whether a use rate of resources of the computer exceeds a threshold value, and
temporarily stop the virtual machine being operated, when the use rate exceeds the threshold value and the virtual machine being operated is the second virtual machine.

10. The information processing device according to claim 9, wherein the processor is configured to:
resume another virtual machine being temporarily stopped when the use rate does not exceed the threshold value.

11. The information processing device according to claim 10, wherein the processor is configured to:
determine whether the virtual machine being operated is in a specific state, and
when the virtual machine being operated is in the specific state and the virtual machine being operated is the first virtual machine, change the virtual machine being operated to the second virtual machine.

12. The information processing device according to claim 11, wherein the processor is configured to:
when the virtual machine being operated is not in the specific state and the virtual machine being operated is the second virtual machine, change the virtual machine being operated to the first virtual machine.

13. The information processing device according to claim 12, wherein the specific state includes at least any one of a state where a traffic amount is a specific value or less, a state where the virtual machine is operating without receiving any input from a user, and a state where the virtual machine does not establish a communication at a network port of a specific port number.

14. The information processing device according to claim 9, wherein the processor is configured to:
determine the threshold value based on the use rate during a most recent specific period.

15. A non-transitory computer-readable storage medium storing a control program for causing a computer to execute a process, the process comprising:
determining which one of a first virtual machine that executes a real-time process and a second virtual machine that executes a batch process a virtual machine being operated is;
stopping the virtual machine being operated, when a process executed by the virtual machine being operated is finished and the virtual machine being operated is the second virtual machine; and
maintaining operation of the virtual machine being operated, when the process executed by the virtual machine being operated is finished and the virtual machine being operated is the first virtual machine.

16. The non-transitory computer-readable storage medium according to claim 15, the process further comprising:
determining whether a use rate of resources of the computer exceeds a threshold value; and
temporarily stopping the virtual machine being operated, when the use rate exceeds the threshold value and the virtual machine being operated is the second virtual machine.

17. The non-transitory computer-readable storage medium according to claim 16, the process further comprising:
resuming another virtual machine being temporarily stopped when the use rate does not exceed the threshold value.

18. The non-transitory computer-readable storage medium according to claim 17, the process further comprising:
determining whether the virtual machine being operated is in a specific state; and
when the virtual machine being operated is in the specific state and the virtual machine being operated is the first virtual machine, changing the virtual machine being operated to the second virtual machine.

19. The non-transitory computer-readable storage medium according to claim 18, the process further comprising:
when the virtual machine being operated is not in the specific state and the virtual machine being operated is the second virtual machine, changing the virtual machine being operated to the first virtual machine.

20. The non-transitory computer-readable storage medium according to claim 19, wherein the specific state includes at least any one of a state where a traffic amount is a specific value or less, a state where the virtual machine is operating without receiving any input from a user, and a state where the virtual machine does not establish a communication at a network port of a specific port number.
